(19) United States
(12) Patent Application Publication
(10) Pub. No.: US 2019/0352539 A1
(43) Pub. Date: Nov. 21, 2019

(54) CONNECTION STRUCTURE

(71) Applicants: AutoNetworks Technologies, Ltd., Mie (JP); Sumitomo Wiring Systems, Ltd., Mie (JP); Sumitomo Electric Industries, Ltd., Osaka (JP)

(72) Inventors: Yu Muronoi, Mie (JP); Takashi Takada, Mie (JP); Kazumasa Kobayashi, Mie (JP)

(21) Appl. No.: 16/476,944

(22) PCT Filed: Jan. 10, 2018
(86) PCT No.: PCT/JP2018/000356

§ 371 Date: Jul. 10, 2019

(30) Foreign Application Priority Data
Jan. 16, 2017 (JP) 2017-004891

(51) Int. Cl. C09J 7/22; H01R 13/52

(52) U.S. Cl. CPC C09J 7/22; H01R 13/52

(57) ABSTRACT

Provided is an connection structure (1) with which the adhesive power between an adhesive agent layer (2) and a connector (3) can be increased, and which maintains high waterproof reliability over a long period of use. The connection structure (1) comprises an adhesive agent layer (2), and a connector (3) including an adhesive surface (30) in contact with a layer surface of the adhesive agent layer (2). The adhesive surface (30) includes a surface irregularity portion (31) having a recess (311) and a protrusion (312). A part of the adhesive agent layer (2) is disposed in the recess (311). The connection structure (1) may be configured to include a fibrous material (5) traversing the recess (311). The connector (3) may be configured from an engineering plastic.

### TECHNICAL FIELD

The present invention relates to a connection structure.

### BACKGROUND

Conventionally, connection structures that have an adhesive layer and a connector are used in various fields.

For example, in the field of vehicles such as automobiles, electric wires are connected to a control box via connectors in order to supply electric power and signals to an electronic control circuit in the control box (see Patent Document 1). The connectors are often separate from the control box. For this reason, a gap is formed when the control box and a connector are connected to each other. If there is a gap, water enters the control box through this gap, causing a failure. To prevent this, the gap between the control box and a connector is filled with an adhesive, and the adhesive is hardened. At this time, a connection structure that has an adhesive layer and the connector is formed.

### PRIOR ART DOCUMENT

### Patent Documents

Patent Document 1: JP 2004-186039A

### SUMMARY OF THE INVENTION

### Problems to be Solved

The method of using an adhesive layer is widely applicable since it can be used in any kind of structure, compared with a method using a rubber packing, to which it is necessary to continue to apply pressure constantly to ensure water resistance. However, to achieve heat resistance or the like, the connectors have been increasingly made of a material such as an engineering plastic to which it is difficult for an adhesive to adhere. Thus, the method of using an adhesive layer cannot keep high adhesiveness, resulting in a situation where it is difficult to ensure sufficient water resistance.

It is also conceivable to introduce a functional group or add an additive for increasing reactivity to increase the adhesiveness of the adhesive layer. According to such a formulation, however, there is a concern that heat resistance, moisture resistance, chemical resistance, and the like of the adhesive layer will deteriorate, and the reliability in terms of water resistance will decrease during long-term use.

The present invention has been made in view of the foregoing circumstances, and is for providing a connection structure that can increase adhesive force between an adhesive layer and a connector and has high reliability in terms of water resistance during long-term use.

### Means to Solve the Problem

An aspect of the present invention is a connection structure including: an adhesive layer; and a connector having an adhesion surface that is in contact with a layer surface of the adhesive layer,

wherein the adhesion surface has a surface protrusion/recess portion having a recessed portion and a protruding portion, and

a portion of the adhesive layer is inserted into the recessed portion.

### Effect of the Invention

In the above connection structure, a portion of the adhesive layer is inserted into the recessed portion of the adhesion surface of the connector that has the surface protrusion/recess portion. Due to this configuration, the adhesion area between the connector and the adhesive layer is greater than that in the case where the surface protrusion/recess portion is not provided. In addition, a mechanical anchor effect occurs between the connector and the adhesive layer, in addition to chemical adhesion between the connector and the adhesive layer. For this reason, with the above connection structure, the adhesive force between the connector and the adhesive layer can be increased. Also, with the above connection structure, introduction of a functional group and addition of an additive for increasing reactivity into the adhesive layer can be suppressed. For this reason, with the above connection structure, heat resistance, moisture resistance, chemical resistance, and the like of the adhesive layer hardly deteriorate, and the reliability in water resistance during long-term use can be increased. For example, in the case where the adhesive layer is made of a silicone adhesive, usually, a functional group is often introduced, or a silane coupling agent is often added, to increase adhesiveness. With the above connection structure, the reliability in terms of water resistance during long-term use can be increased even in the case where the adhesive layer is made of a silicone adhesive for which introduction of a functional group, addition of a silane coupling agent, or the like is suppressed.

### BRIEF DESCRIPTION OF THE DRAWINGS

FIG. 1 is an illustrative diagram that schematically shows a portion of a connection structure according to Embodiment 1.

FIG. 2 is an illustrative diagram that enlarges a cross section of a surface protrusion/recess portion of the connection structure according to Embodiment 1.

FIG. 3 is an illustrative diagram that enlarges a cross section of a surface protrusion/recess portion of a connection structure according to Embodiment 2.

FIG. 4 is an illustrative diagram that enlarges a cross section of a surface protrusion/recess portion of a connection structure according to Embodiment 3.

FIG. 5 is an illustrative diagram that enlarges a cross section of a surface protrusion/recess portion of a connection structure according to Embodiment 4.

FIG. 6 is an illustrative diagram that schematically shows a portion of a connection structure according to Embodiment 5.

FIG. 7A shows an optical image of a surface protrusion/recess portion on a plastic plate material with a depth of groove portions of 50 μm and a pitch between the groove portions of 100 μm in an experimental example.

FIG. 7B shows an optical image of a surface protrusion/recess portion on a plastic plate material with a depth of groove portions of 50 μm and a pitch between the groove portions of 200 μm in an experimental example.

FIG. 8 is a graph depicting a relationship between the pitch between the groove portions and adhesive strength in an experimental example.

FIG. 9 is a graph depicting a relationship between the depth of the groove portions and adhesive strength in an experimental example.

### DETAILED DESCRIPTION TO EXECUTE THE INVENTION

In the above connection structure, one layer surface of the adhesive layer is in contact with the adhesion surface of the connector. Note that the other layer surface of the adhesive layer will come into contact with a counterpart member that is to be adhered to the connector via the adhesive layer when the connection structure is used. Accordingly, the surface shape of the other layer surface of the adhesive layer is determined by the surface shape of the counterpart member.

In the above connection structure, specifically, the adhesive layer may be a layer for adhering the connector and a metal member to each other. More specifically, examples of the metal member may include a metal control box that accommodates an electronic control circuit that is to be mounted in a vehicle, such as an automobile. According to conventional technology, the adhesive force between the metal control box and the adhesive layer tends to be greater than the adhesive force between the connector and the adhesive layer. For this reason, if the adhesive layer is destroyed and the connector is removed, the adhesive layer is left on the control box side, and it is then difficult to reuse the control box. In contrast, according to the above configuration, the adhesive force between the connector and the adhesive layer can be made greater than the adhesive force between the metal control box and the adhesive layer. As a result, a configuration can be made in which, when the adhesive layer is destroyed and the connector is removed, the adhesive layer tends to be left on the connector side, and is hardly left on the control box side. Therefore, according to the above configuration, a connection structure can be obtained that facilitates reuse of a metal member, such as a metal control box.

In the above connection structure, the adhesion surface of the connector has a surface protrusion/recess portion that includes a large number of recessed portions and a large number of protruding portions. The surface protrusion/recess portion may be provided in a portion or the entirety of the adhesion surface. Specifically, the recessed portions may be constituted by a plurality of groove portions, a plurality of hole portions, a combination thereof, or the like, for example. Preferably, the recessed portions may be constituted by a plurality of groove portions. According to this configuration, the adhesion area can be readily increased when the adhesive layer is adhered, compared with the case where the recessed portions are constituted by a plurality of hole portions, and thus, the aforementioned effect can be further ensured. More specifically, the recessed portions may be constituted by a plurality of linear groove portions. In this case, for example, the recessed portions may have a configuration in which a plurality of linear groove portions that are oriented in one direction are arranged separately from each other in a direction intersecting (e.g., a direction perpendicular to) the one direction. Also, the recessed portions may alternatively be configured by arranging a plurality of linear groove portions into a lattice (i.e., in a tessellated manner), for example. Note that, in the case where the recessed portions are constituted by hole portions, more specifically, the recessed portions may be constituted by a plurality of non-through holes. In this case, for example, the recessed portions may be configured by arranging the plurality of non-through holes separately from each other in a row direction and a column direction.

The opening distance of each recessed portion in the depth direction can be made substantially uniform in the depth direction thereof. Also, the opening distance of each recessed portion in the depth direction may decrease toward the depth direction thereof. Alternatively, the opening distance of each recessed portion in the depth direction may increase toward the depth direction thereof. According to this configuration, even if a load is applied from the connector in a direction in which the adhesive layer is peeled away, a portion of the adhesive layer that is inserted into each recessed portion is hooked at the recessed portion and it is difficult for the adhesive layer to come out of the recessed portion. For this reason, according to this configuration, the adhesive force between the connector and the adhesive layer can be further increased, and water resistance can be ensured more reliably. Note that the aforementioned “opening distance” means the distance between wall faces of each recessed portion in the direction perpendicular to the depth direction of the recessed portion. Accordingly, if the recessed portions are groove portions, the opening distance of each recessed portion in the depth direction is the distance between the wall faces of the groove portion in a direction perpendicular to the depth direction of the groove portion (i.e., the width of the groove portion in the direction perpendicular to the depth direction of the groove portion). If the recessed portions are hole portions, the opening distance of each recessed portion in the depth direction is the distance between wall faces of the hole portion in a direction perpendicular to the depth direction of the hole portion (i.e., the opening aperture in the direction perpendicular to the depth direction of the hole portion). For example, the recessed portions may be formed by means of laser etching, plasma etching, chemical etching, grinding, a combination thereof, or the like.

The depth of the recessed portions may be preferably 30 μm or more, more preferably 50 μm or more, and yet more preferably 80 μm or more, in terms of the formation of the recessed portions, ensuring of the adhesive force, and the like. Meanwhile, the depth of the recessed portions may be preferably 300 μm or less, more preferably 150 μm or less, and yet more preferably 120 μm or less, in terms of ensuring of the adhesion area, suppression of damage on the connector material, and the like.

In the above connection structure, the connector may be made of, specifically, an engineering plastic. An engineering plastic is a material to which it is difficult for an adhesive to adhere. For this reason, employment of the above configuration makes it possible to ensure the adhesive force between the connector and the adhesive layer even if the connector is made of an engineering plastic, and a connection structure that can readily ensure water resistance can be obtained. Usually, even an adhesive that is less adhesive to an engineering plastic can be applied to the adhesive layer, and water resistance can be ensured. Examples of the engineering plastic may include polybutylene terephthalate resin, polyphenylene sulfide resin (PPS), polypropylene, polyethylene terephthalate, nylon, polycarbonate, polyacetal, fluorocarbon resin, polyarylate, liquid crystal polymer, polysulfone, polyethersulfone, polyetheretherketone, polyetherimide, polyamide-imide, and so on. The engineering plastic may contain a later-described fibrous material or the like.

In the above connection structure, the connector may be configured to have a fibrous material that traverses the inside of the recessed portions. According to this configuration, the fibrous material that traverses the inside of the recessed portions passes through a portion of the adhesive layer that is inserted into each recessed portion. For this reason, according to this configuration, it is difficult for the portion of the adhesive layer that is inserted into each recessed portion to be pulled out due to the fibrous material that spans over (bridges) the spaces within the recessed portion, the adhesive force between the connector and the adhesive layer then increases, and water resistance can be ensured more reliably.

Preferable examples of the fibrous material may include inorganic fibers, such as glass fiber and ceramic fiber. One or two or more of these types of inorganic fibers can be used together. In the case where the aforementioned fibrous material is an inorganic fiber, a structure in which the fibrous material traverses the inside of the recessed portion can be formed relatively easily by including the fibrous material in the connector material, and selectively etching an organic component, such as a resin component, within the connector material, by means of laser etching, plasma etching, chemical etching, a combination thereof, or the like, to form the recessed portions.

In the above connection structure, basically, any material that is adhesive to the connector material can be used as the material of the adhesive layer. This is because, with a certain degree of adhesiveness to the connector material, employment of the above configuration makes it possible to ensure the adhesive force between the connector and the adhesive layer and exhibit water resistance.

Specifically, examples of the adhesive that constitutes the adhesive layer may include a silicone adhesive, an epoxy adhesive, an acrylic adhesive, an urethane adhesive, and the like. Of these adhesives, preferably, a silicone adhesive or the like may be used as the adhesive in terms of heat resistance or the like. Note that a portion of the adhesive layer can be caused to enter each recessed portion of the adhesion surface to fill the recessed portion with the adhesive by applying the adhesive over the adhesion surface of the connector.

The adhesive layer may contain a filler. Note that use of the filler is advantageous in that the strength of the adhesive is increased, operability is improved by increasing the viscosity of the adhesive, and the cost per volume is reduced by filling the recessed portions with a filler with a low unit price, for example. Examples of the filler may include silica, aluminum, alumina, calcium carbonate, carbon black, and so on. One or two or more of these materials can be used together.

In the case where the adhesive layer contains a filler, the size of an entrance opening of the recessed portion may be larger than the outer diameter of the filler. According to this configuration, when the adhesion for forming the adhesive layer is applied to the surface protrusion/recess portion of the adhesion surface, it is difficult for the filler to inhibit the adhesive from entering the recessed portions, and a fine structure in which a portion of the adhesive layer is inserted into each recessed portion can be readily formed. More specifically, in the case where the recessed portions are constituted by groove portions, the size of the entrance opening of each recessed portion is the groove width of the entrance portion of each groove portion. In the case where the recessed portions are constituted by hole portions, the size of the entrance opening of each recessed portion is the diameter of the entrance portion of each hole portion. Note that the relationship regarding which is larger or smaller between the size of the entrance opening of each recessed portion and the outer diameter of the filler can be understood by observing the cross section of each recessed portion, for example.

The size of the entrance opening of each recessed portion may be preferably 5 μm or more, more preferably 7 μm or more, and yet more preferably 10 μm or more. In this case, the flowability of the adhesive into the recessed portions when the connection structure is manufactured increases, and a structure in which a portion of the adhesive layer is inserted into each recessed portion is achieved more reliably. Meanwhile, the size of the entrance opening of the recessed portion may be preferably 200 μm or less, more preferably 150 μm or less, and yet more preferably 100 μm or less, in terms of ensuring of a sufficient adhesion area between the recessed portions and the adhesive layer, and the like.

Note that the above-described configurations can be combined in any manner as needed to achieve the above-described effects, for example.

### Embodiments

Connection structures according to the embodiments will be described below with reference to the drawings. Note that the same members will be described with reference to the same reference numerals.

### Embodiment 1

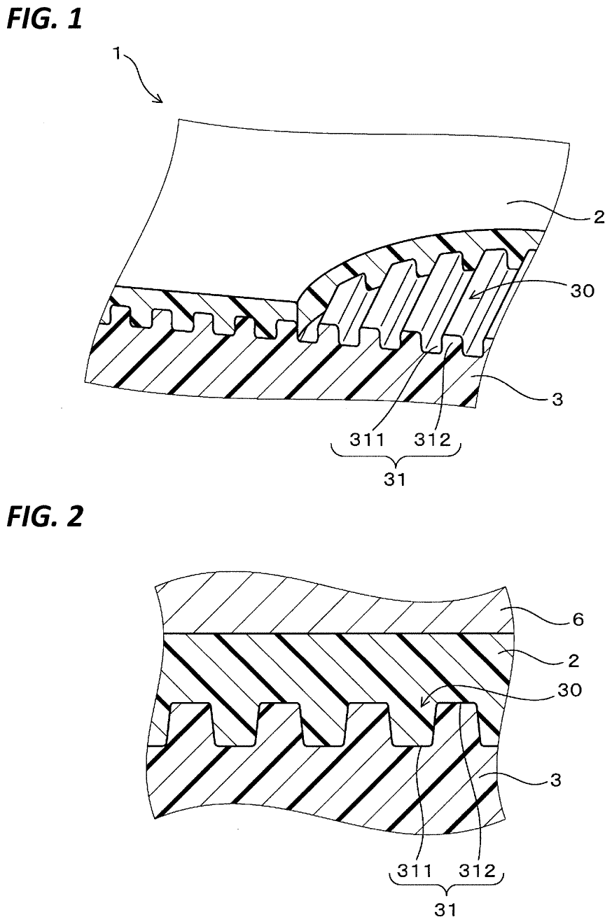

A connection structure according to Embodiment 1 will be described with reference to FIGS. 1 and 2. As shown in FIGS. 1 and 2, a connection structure 1 in this example has an adhesive layer 2 and a connector 3 that has an adhesion surface 30 that is in contact with a layer surface of the adhesive layer 2. In this example, the other layer surface of the adhesive layer 2 is brought into contact with a metal member 6. Specifically, in this example, the other layer surface of the adhesive layer 2 is brought into contact with a metal control box that serves as the metal member 6 and accommodates an electronic control circuit. That is to say, the connection structure in this example is used to connect an electric wire via a connector to supply electric power or signals to the electronic control circuit in the metal control box. Note that FIG. 1 omits the metal member 6. Also, FIG. 2 schematically shows a portion of the metal member 6. Note that the connector 3 also has a non-adhesion surface (not shown) that is not in contact with the adhesive layer 2.

Here, the adhesion surface 30 has a surface protrusion/recess portion 31, which includes recessed portions 311 and protruding portions 312. In this example, the recessed portions 311 are constituted by a plurality of groove portions. More specifically, the recessed portions 311 have a configuration in which a plurality of linear groove portions, which are oriented in one direction, are arranged separately from each other in a direction perpendicular to the one direction. The groove width of an entrance portion of each groove portion may be 20 to 150 μm, for example. The pitch between adjacent groove portions may be, for example, 50 to 300 μm. The depth of the groove portions may be 50 to 150 μm. Note that, in this example, the width of each groove portion in a direction perpendicular to the depth direction of the groove portion decreases toward the depth direction of the groove portion. The recessed portions 311 in this mode can be formed by means of laser etching.

A portion of the adhesive layer 2 is inserted into each of the recessed portions 311 of the surface protrusion/recess portion 31, and each of the recessed portions 311 is filled with the adhesive that constitutes the adhesive layer 2. In this example, specifically, the connector 3 is made of an engineering plastic, such as polybutylene terephthalate. Specifically, the adhesive that constitutes the adhesive layer is a silicone adhesive.

Next, the effects of the connection structure in this example will be described.

In the connection structure 1 in this example, a portion of the adhesive layer 2 is inserted into each of the recessed portions 311 in the adhesion surface 30 of the connector 3 that has the surface protrusion/recess portion 31. Due to this configuration, the adhesion area between the connector 3 and the adhesive layer 2 is greater than that in the case where the surface protrusion/recess portion 31 is not provided. In addition, a mechanical anchor effect occurs between the connector 3 and the adhesive layer 2, in addition to chemical adhesion between the connector 3 and the adhesive layer 2. For this reason, with the connection structure 1 in this example, the adhesive force between the connector 3 and the adhesive layer 2 can be increased. Also, with the connection structure 1 in this example, introduction of a functional group and addition of an additive for increasing reactivity into the adhesive layer 2 can be suppressed. For this reason, with the connection structure 1 in this example, heat resistance, moisture resistance, chemical resistance, and the like of the adhesive layer 2 hardly deteriorate, and the reliability in water resistance during long-term use can be increased. In the case where the adhesive layer 2 is made of a silicone adhesive, usually, a functional group is often introduced, or a silane coupling agent is often added, to increase adhesiveness. With the connection structure 1 in this example, the reliability in water resistance during long-term use can be increased even in the case where the adhesive layer 2 is made of a silicone adhesive for which introduction of a functional group, addition of a silane coupling agent, or the like is suppressed.

Also, with the connection structure 1 in this example, the adhesive force between the connector 3 and the adhesive layer 2 can be made larger than the adhesive force between the control box serving as the metal member 6 and the adhesive layer 2. For this reason, a configuration can be achieved in which, when the connector 3 is removed, the adhesive layer 2 tends to be left on the connector 3 side and is hardly left on the control box side. Therefore, with the above connection structure 1, a connection structure 1 is obtained that facilitates reuse of the metal control box.

### Embodiment 2

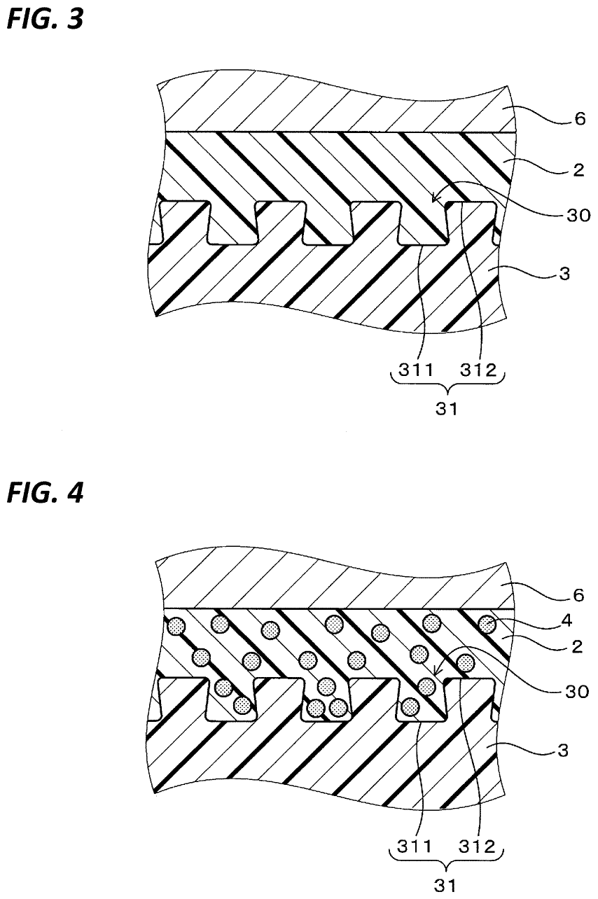

A connection structure according to Embodiment 2 will be described with reference to FIG. 3.

In a connection structure 1 in this example, the recessed portions 311 are configured such that the opening distance in the depth direction thereof increases toward the depth direction. The recessed portions 311 in this mode can be formed by performing laser etching and then performing chemical etching. Other configurations are the same as those of Embodiment 1.

With the connection structure 1 in this example, even if a load is applied in a direction in which the adhesive layer 2 is peeled away from the connector 3, a portion of the adhesive layer 2 that is inserted into each of the recessed portions 311 is hooked at the recessed portion 311, and it is difficult for the adhesive layer 2 to come out of the recessed portion 311. For this reason, according to the above configuration, the adhesive force between the connector 3 and the adhesive layer 2 can be further increased, and water resistance can be ensured more reliably. The other effects are the same as those of Embodiment 1.

### Embodiment 3

A connection structure according to Embodiment 3 will be described with reference to FIG. 4.

In a connection structure 1 in this example, the adhesive layer 2 contains a filler 4. In this example, the filler 4 has a spherical shape. Specifically, the filler 4 may be silica. The size of the entrance opening of each recessed portion 311 is formed larger than the outer diameter of the filler 4. That is to say, in this example, the groove width of the entrance portion of each groove portion is formed larger than the outer diameter of the filler 4.

With the connection structure 1 in this example, when an adhesive for forming the adhesive layer 2 is applied to the surface protrusion/recess portion 31 of the adhesion surface 30, it is difficult for the filler 4 to inhibit the adhesive from entering the recessed portions 311, and a fine structure in which a portion of the adhesive layer 2 is inserted into each of the recessed portions 311 can be readily formed. The other effects are the same as those of Embodiment 2.

### Embodiment 4

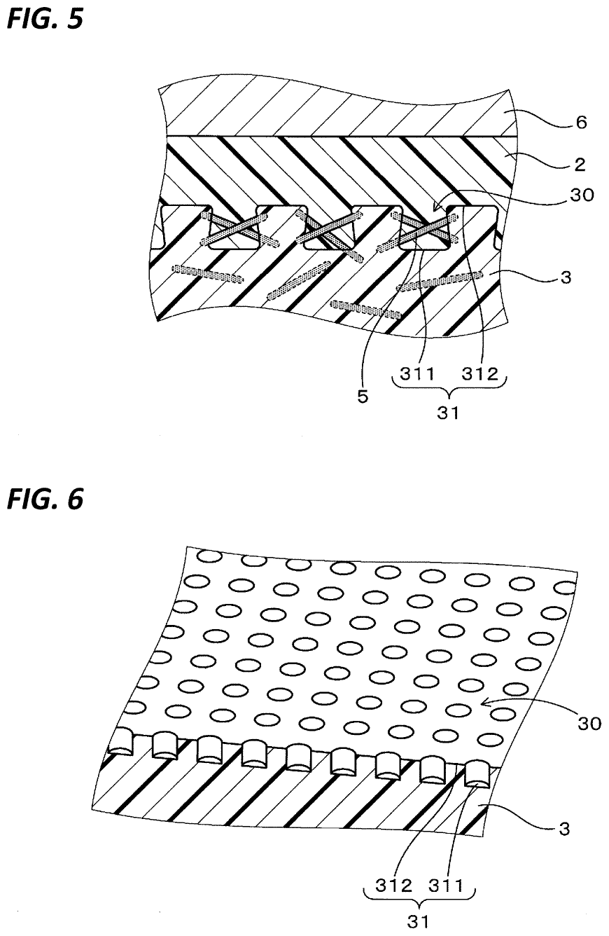

A connection structure according to Embodiment 4 will be described with reference to FIG. 5.

In a connection structure 1 in this example, the connector 3 has a fibrous material 5 that traverses the inside of the recessed portions 311. In this example, the fibrous material 5 may be an inorganic fiber. The fibrous material 5 is also present inside of the connector 3. That is to say, in this example, the fibrous material 5 that is contained in the connector material is exposed to the recessed portions 311, and is present while traversing the inside of the recessed portions 311. Other configurations are the same as those of Embodiment 2.

With the connection structure 1 in this example, the fibrous material that traverses the inside of the recessed portions 311 passes through a portion of the adhesive layer 2 that is inserted into each of the recessed portions 311. As a result, with the connection structure 1 in this example, the adhesive layer 2 that is inserted into the recessed portions 311 can be hardly pulled out due to the fibrous material 5 that spans over (bridges) the spaces within the recessed portions 311, the adhesive force between the connector 3 and the adhesive layer 2 increases, and water resistance can be ensured more reliably. The other effects are the same as those of Embodiment 2.

### Embodiment 5

A connection structure according to Embodiment 5 will be described with reference to FIG. 6. Note that FIG. 6 corresponds to FIG. 1 but omits the adhesive layer 2 for convenience.

In a connection structure 1 in this example, the recessed portions 311 are constituted by a plurality of hole portions. More specifically, the recessed portions 311 have a configuration in which a plurality of non-through hole portions are arranged separately from each other in a row direction and in a column direction. The diameter of the entrance portion of each hole portions may be 20 to 200 μm, for example. The interval between adjacent hole portions may be 50 to 300 μm, for example. The depth of the hole portions may be 50 to 150 μm. Note that, in this example, the opening diameter of each hole portion in a direction perpendicular to the depth direction thereof is substantially fixed in the depth direction of the hole portion. Other configurations are the same as those of Embodiment 1.

With the connection structure 1 in this example as well, the adhesive force between the adhesive layer 2 and the connector 3 can be increased, and a connection structure 1 with high reliability in water resistance during long-term use can be obtained, similarly to Embodiment 1.

### Experimental Examples

The above-described connection structure will be described below more specifically using experimental examples.

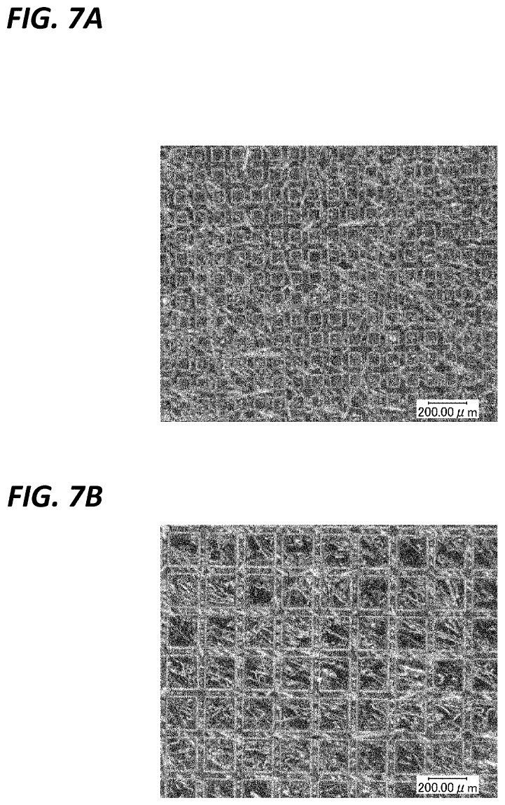

A plurality of plastic plate materials, each of which simulated a resin connector housing, were prepared. The plastic plate materials are made of polybutylene terephthalate that contains glass fiber. Groove portions with different depths were formed in a lattice arrangement with different pitches between the groove portions, by performing laser etching on one surface of each of the prepared plastic plate materials while changing processing conditions. Note that the width of each groove portion in a direction perpendicular to the depth direction thereof decreases toward the depth direction of the groove portion. The depth of the groove portions and the pitch between the groove portions were adjusted by changing the laser intensity, laser spot diameter, pulse width, and radiation time. As representative examples, FIG. 7A shows an optical image of the surface protrusion/recess portion on a plastic plate material with the depth of the groove portions being 50 μm and the pitch between the groove portions being 100 μm, and FIG. 7B shows an optical image of the surface protrusion/recess portion on a plastic plate material with the depth of the groove portions being 50 μm and the pitch between the groove portions being 200 μm. By selectively etching only polybutylene terephthalate while changing conditions in laser etching as mentioned above, it was confirmed that glass fiber was allowed to be present so as to traverse the spaces in the formed groove spaces (i.e., in the recessed portions), as shown in FIGS. 7A and 7B.

Next, an adhesive 1 (condensation-type silicone adhesive, manufactured by ThreeBond Co., Ltd., “TB1207F”, which contains a filler whose outer diameter is smaller than the entrance opening of each of the formed recessed portions) was applied, at a thickness of 100 μm, to plate surfaces of the plastic plate materials in each of which the surface protrusion/recess portion was formed to cause the adhesive to flow into the recessed portions, and a metal plate (which simulated a control box) was adhered to each of the formed adhesive layers to make a plurality of test bodies. Also, a plurality of test bodies were made similarly, except for using an adhesive 2 (silicone adhesive, manufactured by ThreeBond Co. Ltd., “TB1282B”, which contains a filler whose outer diameter is smaller than the entrance opening of each of the formed recessed portions) in place of the adhesive 1. Also, a test body for comparison was made similarly, except for using a plate material in which the surface protrusion/recess portion was not formed.

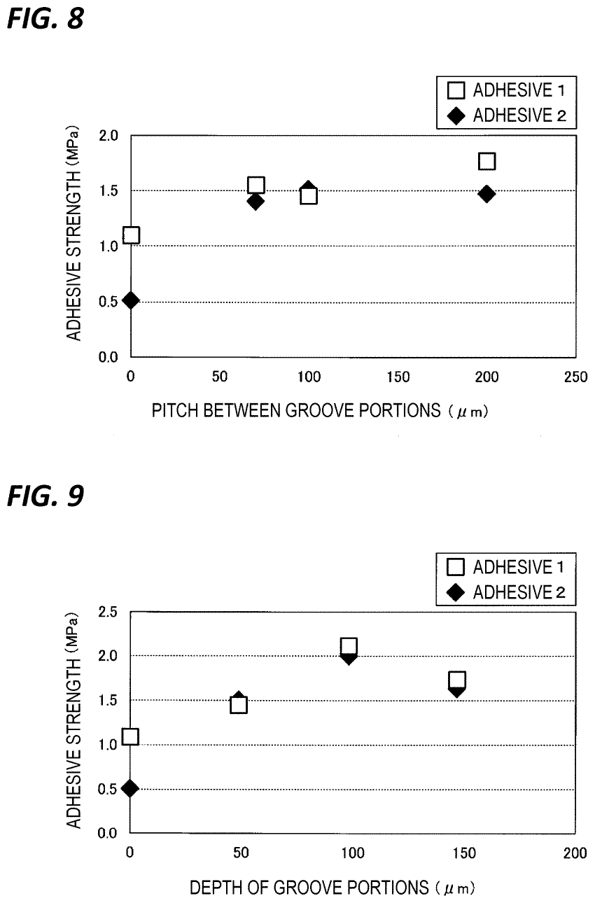

Next, a shear-tension test, in which the plastic plate material and a metal plate were torn off from each other, was performed and the adhesive strength was obtained for each of the test bodies. FIG. 8 shows a relationship between the pitch between the groove portions and the adhesive strength. FIG. 9 shows a relationship between the depth of the groove portions and the adhesive strength.

As shown in FIGS. 8 and 9, it was confirmed that, in the cases where the surface protrusion/recess portion was formed on a plate surface of a plastic plate material, the adhesive strength increased with any of the adhesives compared with the case where the surface protrusion/recess portion was not formed on a plate surface of a plastic plate material. Also, in all of the cases where the surface protrusion/recess portion was formed on a plate surface of a plastic plate material, the mode of destruction was adhesive destruction. On the other hand, in the cases where the surface protrusion/recess portion was not formed on a plate surface of a plastic plate material, the interface between the plastic plate material and the adhesive layer was destroyed with any of the adhesives. From these results, it can be said that the adhesive force between the connector and the adhesive layer is increased and water resistance is ensured for a long period of time by forming the surface protrusion/recess portion on the adhesion surface of the connector and causing a portion of the adhesive layer entering each of the recessed portion.

Although the embodiments of the present invention have been described in detail, the present invention is not limited to the above-described embodiments and experimental examples, and may be modified in various manners without losing the gist of the present invention.

1. A connection structure comprising:
an adhesive layer; and
a connector having an adhesion surface that is in contact with a layer surface of the adhesive layer,
wherein the adhesion surface has a surface protrusion/recess portion having a recessed portion and a protruding portion,
a portion of the adhesive layer is inserted into the recessed portion, and
a fibrous material included in a material of the connector is exposed to the recessed portion, and is present while traversing inside of the recessed portion so as to span over a space within the recessed portion.

2. The connection structure according to claim 1, wherein the fibrous material is an inorganic fiber.

3. The connection structure according to claim 1,
wherein the adhesive layer contains a filler, and
a size of an entrance opening of the recessed portion is larger than an outer diameter of the filler.

4. The connection structure according to claim 1,
wherein an opening distance of the recessed portion in a depth direction thereof increases toward the depth direction.

5. The connection structure according to claim 1,
wherein the recessed portion is constituted by a plurality of groove portions or a plurality of hole portions.

6. The connection structure according to claim 1,
wherein the connector is made of an engineering plastic.

7. (canceled)
